(19) United States
(12) Patent Application Publication
(10) Pub. No.: US 2014/0366973 A1
(43) Pub. Date: Dec. 18, 2014

(54) DRAIN ARRANGEMENT FOR A MOBILE LIQUID STORAGE TANK

(71) Applicant: The International Tank Corporation, Sylvan Lake (CA)

(72) Inventors: Jarvis A. Jackson, Sylvan Lake (CA); Pierre H. Meunier, Whitecourt (CA)

(21) Appl. No.: 13/916,052

(22) Filed: Jun. 12, 2013

(51) Int. Cl. B60P 3/22

(52) U.S. Cl. CPC B60P 3/2245
USPC 137/899

(57) ABSTRACT

A mobile liquid storage tank includes a sump located below the floor level of the tank at an end wall of the tank. A suction pipe has an inlet positioned within the sump so that the tank is substantially completely emptied as the liquid is withdrawn from the tank.

### BACKGROUND OF INVENTION

1. Field of the Invention

This invention is directed to a mobile liquid storage tank and in particular to a drain arrangement for facilitating complete removal of the liquid from the storage tank.

2. Description of Related Art

Numerous designs for mobile liquid storage tanks have been proposed. These tanks are typically required for remote field activities where a source of liquid for example water, is not readily available. One such activity which requires a substantial amount of liquid, namely water, is the treatment of oil or gas wells for various purposes one of which is the well fracturing process. A well fracturing process may require several large mobile water storage tanks.

During such a process, it is highly desirable to withdraw as much of the water from the tanks This reduces the overall cost of the procedure and also conserves natural resources.

One design as disclosed in U.S. Pat. No. 6,173,991, for these storage tanks includes a sloping floor that slopes from each side to a longitudinal centerline and from the rear of the tank to the front.

### BRIEF SUMMARY OF THE INVENTION

The present invention resides in the provision of a sump at one end of the storage tank which is below the floor level of the tank. A conduit having an inlet positioned within the sump is provided to convey fluid out of the tank. The conduit is connected to the intake of a pump typically through a manifold so that the water may be withdrawn from the tank and injected into the well. In the case of a fracturing process, proppant and chemicals are normally added to the water. The tank may have slopping floors to direct the fluid to the middle of the tank and then to one end of the tank. The tank may be mounted on a skid support structure.

### BRIEF DESCRIPTION OF THE SEVERAL VIEWS OF THE DRAWING(S)

FIG. 1 is a perspective view of a mobile liquid storage tank according to an embodiment of the invention.

FIG. 2 is a top view of the storage tank of FIG. 1 with its top removed.

FIG. 3 is an internal end view of the storage tank shown in FIG. 1.

FIG. 4 is a bottom view of the storage tank shown in FIG. 1

FIG. 5 is an enlarged view of the sump assembly and suction manifold.

FIG. 6 is a perspective view of the tank floor showing the sump and porch structure.

### DETAILED DESCRIPTION OF THE INVENTION

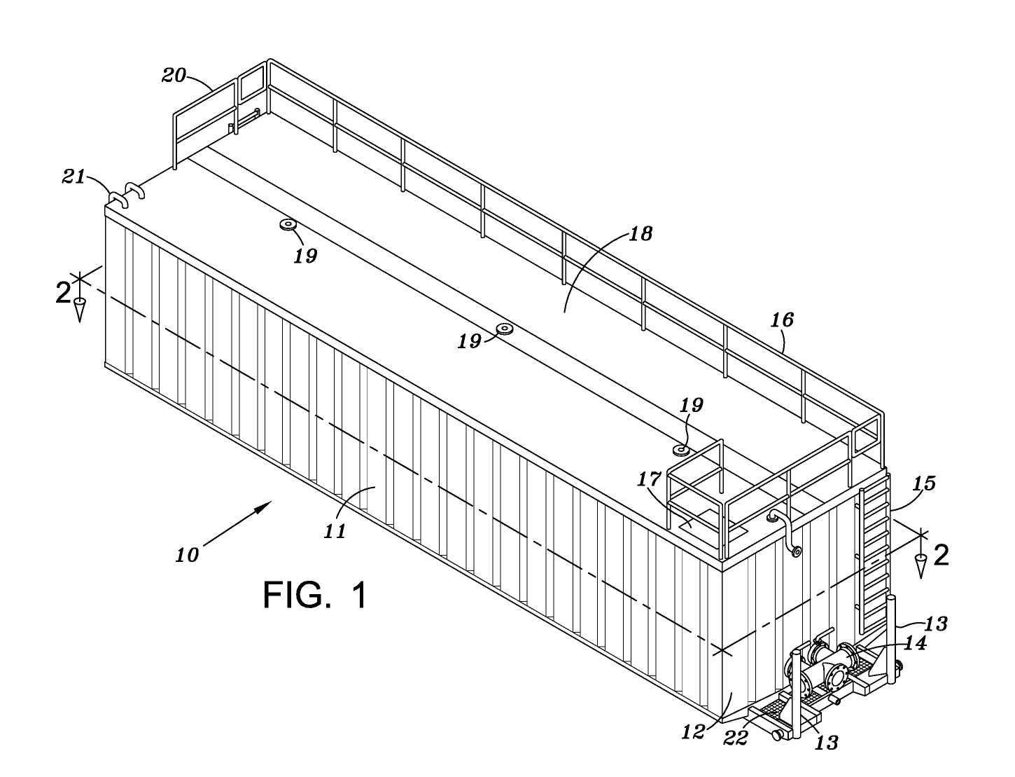

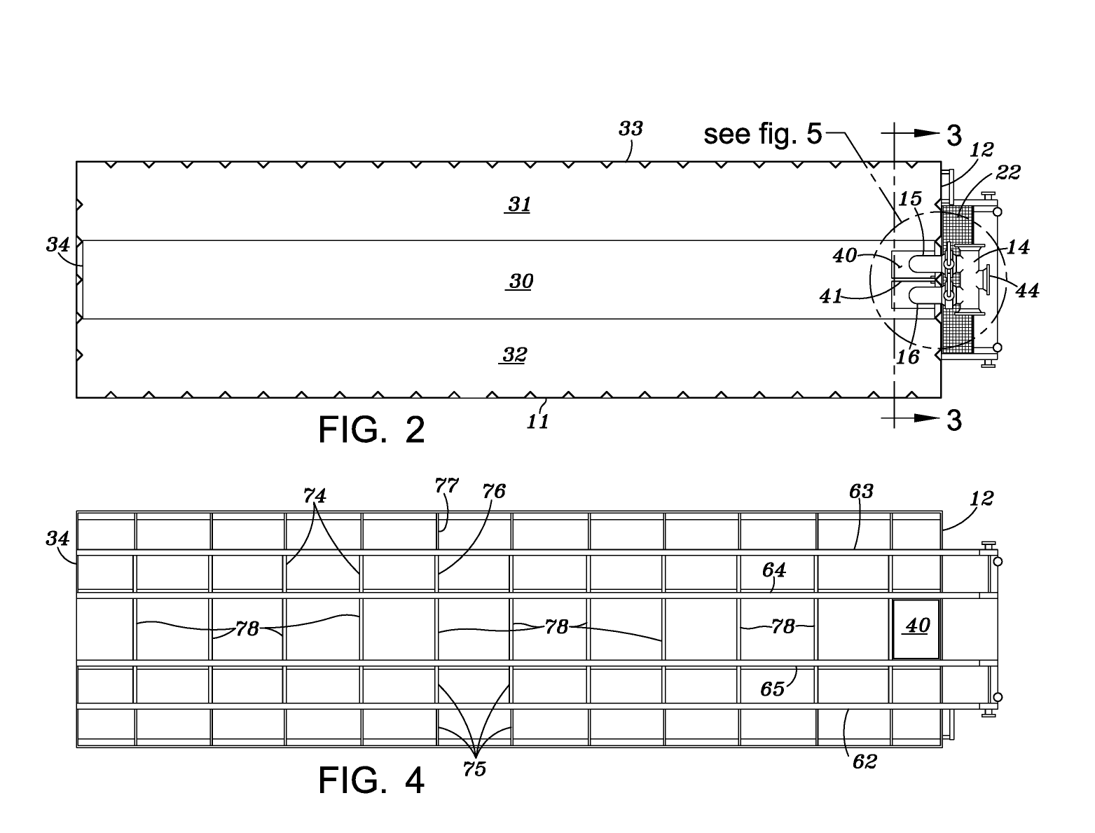

As shown in FIGS. 1 and 2, the mobile fluid storage tank 10 of an embodiment of the invention includes side walls 11 and 33 and a first end wall 12 and a second end wall 34 in the general shape of a rectangle. The tank further includes a floor which includes a middle portion 30 and two side portions 31 and 32. As shown in FIG. 3 side portions 31 and 32 slope downwardly from side walls 11 and 33 to middle floor portion 30. Floor portions 30, 31 and 32 also slope from second end wall 34 to first end wall 12 to assist in draining the fluid. The end and side walls may be formed of corrugated metal as is known in the art. Floor portions 30, 31 and 32 may be formed from a plurality of flat plates. A collapsible rail 20 and 16 is optionally secured to roof 18 of the tank. The roof may also include a plurality of sprinkler fittings 19 for cleaning purposes. Also a suitable vent 21 may be provided for venting the tank. A manway 17 for access into the tank may be provided through the roof. A porch like structure 22 is suspended from first end wall 12 and provides support for a manifold assembly 14 to be described in more detail below.

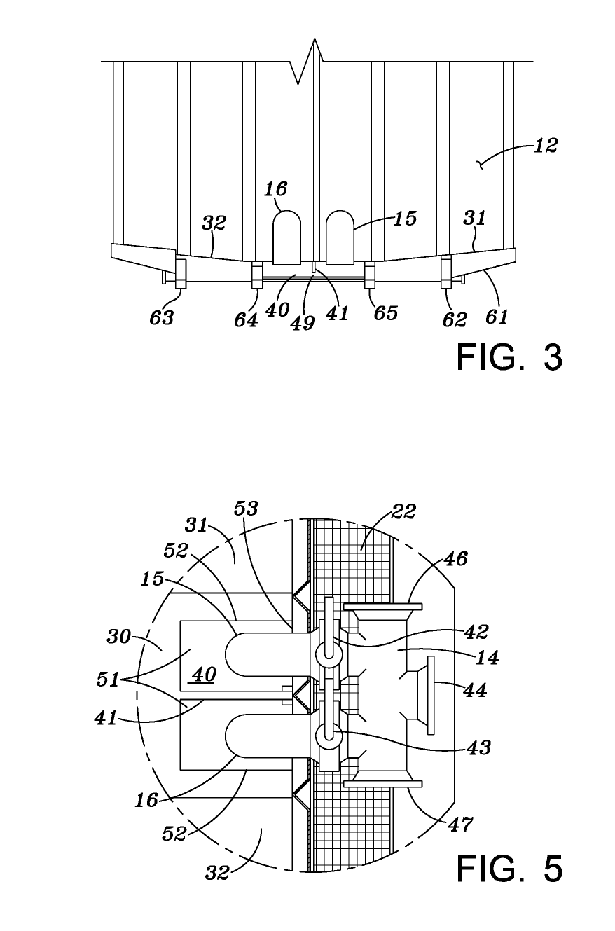

The details of the sump are shown in FIG. 3 which is an interior view of end wall 12. A portion of central floor section 30 is cut out at 51 and a rectangular pan structure having side walls and a bottom is located below the central floor section 30. A baffle 41 extends along the center line of the pan. A pair of suction pipes 15 and 16 extend into the sump pan slightly above the bottom 40 of the pan. Suction pipes 15 and 16 extend upwardly and then through end wall 12 and are connected to a manifold 14 which has a central outlet 44 as shown in FIG. 5. Outlet 44 is connected directly or via a further manifold to a suction side of a pump. Valves 42 and 43 may be provided in suction pipes 15 and 16 to control the flow of fluids therethrough as shown in FIG. 5. Manifold 14 is closed by end plates 46 and 47. The sump pan may include an opening in a side wall thereof and a drain pipe connected to the opening.

FIG. 4 illustrates the bottom structure of the tank. It includes a pair of outer skid members 63 and 62 that extend over the length of the tank and a pair of inner skid members 64 and 65 which also extend lengthwise of the tank. Skid members may be of any suitable shape and construction such as an “I” beam structure or a rectangular box construction. A plurality of floor joists 74, 75, 76 and 77 extend between the skid members to form a support structure for the floor members 30, 31 and 32. Floor joists 76 and 77 are shaped so as to form a slanting floor from the sides of the tank 11 and 33 to middle floor portion 30 and also to form a slanting floor from the second end wall 34 to first end wall 12. Floor joists 78 extend between inner skid members 64 and 65. The bottom of the sump is shown at 40 in FIG. 4. Skids 62, 63, 64 and 65 extend outwardly from end wall 12 and support a grated open porch 22. Porch 22 includes on either side a vertical bumper post 13.

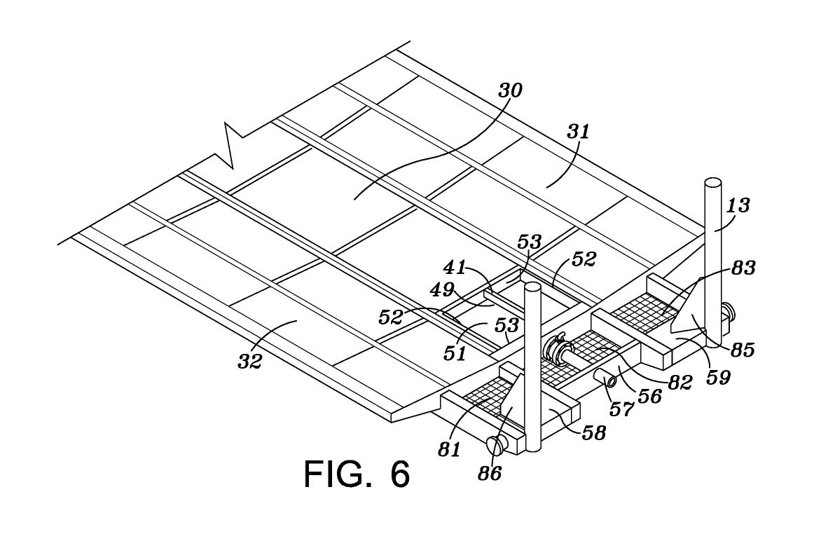

The structure of the sump and porch is illustrated in FIGS. 5 and 6. A rectangular opening 51 is formed in middle floor portion 30. The sump in one embodiment may take the form of a pan having a bottom plate 40 shown in FIG. 4 and upwardly extending side walls 52 and end walls 53. A baffle 41 extends between side walls 53. Baffle 41 is spaced from the bottom of the sump as shown at 49 so that fluid may be completely evacuated from the sump. The pan is positioned below the level of the tank floor by any suitable means such as fixing the side walls and/or end walls to the floor joists and/or the skids 64 and 65.

As shown in FIG. 6, the porch may include bottom plates 81, 82 and 83 and top plates 58 and 59 secured to the skids 64 and 65. Vertical bumpers 13 extend upwardly from the porch and are supported by plates 85 and 86. A drain pipe 57 extends outwardly of the porch.

In operation, the liquid tank having liquid therein is located in the area where the remote supply of fluid is required. Manifold 14 is typically connected to another manifold, which connects a plurality of tanks to the suction inlet of a series of pumps, for example, fracing pumps. Valves 42 and 43 are placed in an open position. As the pumps are activated, liquid will be withdrawn from the tanks via suction pipes 15 and 16. Due to the rear to front and side to middle slopping of the floor of the tank, fluid will be directed by gravity toward the sump at the first end wall 12. Because the sump is located below the level of middle floor portion 30, all of the liquid will eventually be withdrawn from the tank except for a minor amount located in the bottom of the sump. This amount of fluid can be withdrawn via sump evacuation pipe 57. Also suitable drains may be provided in the sump in the side walls or bottom wall to completely drain the tank.

Although the present invention has been described with respect to specific details, it is not intended that such details should be regarded as limitations on the scope of the invention, except to the extent that they are included in the accompanying claims.

I claim:

1. A mobile liquid supply tank comprising:
a pair of side walls;
a first end wall extending between the side walls;
a second end wall extending between the side walls;
a bottom floor forming a bottom for the tank;
a sump located in the bottom floor adjacent one of the end walls, the sump being located below the bottom floor; and
a suction pipe extending through one of the end walls and extending to a location within the sump.

2. A mobile liquid storage tank as claimed in claim 1 wherein the bottom floor has a middle portion and two side portions that slope down from the side walls to the middle portion.

3. A mobile liquid storage tank as claimed in claim 2 wherein the bottom floor slopes downwardly from the second end wall to the first end wall.

4. A mobile liquid storage tank as claimed in claim 1 further comprising a sump drain pipe having an inlet positioned within the sump.

5. A mobile liquid storage tank is claimed in claim 1 further comprising a baffle plate positioned within the sump dividing the sump into two reservoirs, and a second suction pipe, each pipe having an inlet positioned within one of the said reservoirs.

6. A mobile liquid storage tank as claimed in claim 1 further comprising a manifold having an inlet connected to the suction pipe.

7. A mobile liquid storage tank as claimed in claim 6 further comprising a porch extending outward from one of said end walls.
